(19) United States
(12) Patent Application Publication
(10) Pub. No.: US 2014/0240327 A1
(43) Pub. Date: Aug. 28, 2014

(54) FINE-GRAINED CPU-GPU SYNCHRONIZATION USING FULL/EMPTY BITS

(71) Applicant: THE TRUSTEES OF PRINCETON UNIVERSITY, (US)

(72) Inventors: Daniel Lustig, Plainsboro, NJ (US); Margaret Martonosi, Skillman, NJ (US)

(73) Assignee: THE TRUSTEES OF PRINCETON UNIVERSITY, Princeton, NJ (US)

(21) Appl. No.: 13/773,806

(22) Filed: Feb. 22, 2013

(51) Int. Cl. G06T 1/20

(52) U.S. Cl. CPC G06T 1/20
USPC 345/505; 345/501

(57) ABSTRACT

A heterogeneous computing system includes a central processing unit (CPU) and a graphics processing unit (GPU). The CPU and the GPU are synchronized using a data-based synchronization scheme, wherein offloading of a kernel from the CPU to the GPU is coordinated based upon the data associated with the kernel transferred between the CPU and the GPU. By using a data-based synchronization scheme, additional synchronization operations between the CPU and the GPU are reduced or eliminated, and the overhead of offloading a process from the CPU to the GPU is reduced.

### GOVERNMENT SUPPORT

This invention was made with government funds under contract number DARPA HR0011-07-3-0002 awarded by DARPA. The U.S. Government has certain rights in this invention.

### FIELD OF THE DISCLOSURE

The present disclosure relates to graphics processing unit (GPU) architectures suitable for parallel processing in a heterogeneous computing system.

### BACKGROUND

Heterogeneous computing systems are a type of computing system that use more than one kind of processor. In a heterogeneous computing system employing a central processing unit (CPU) and a graphics processing unit (GPU), computational kernels may be offloaded from the CPU to the GPU in order to improve the runtime, throughput, or performance-per-watt of the computation as compared to the original CPU implementation. Although effective at increasing the performance of many throughput-oriented computational kernels, there is an inherent overhead cost involved in offloading computational kernels from a CPU to a GPU. In some cases, the associated overhead costs of a CPU to GPU kernel offload may eliminate the performance gains associated with the use of a heterogeneous computing system altogether.

FIG. 1 shows a schematic representation of a traditional heterogeneous computing system 10 including a CPU 12 and a GPU 14. The CPU 12 and the GPU 14 communicate via a host interface (IF) 16. The architecture of the GPU 14 includes a plurality of streaming multiprocessors 18A-18N, a GPU interconnection network 20, and a plurality of memory partitions 22A-22N. Each one of the plurality of memory partitions 22A-22N includes a memory controller 24A-24N and a portion of off-die global dynamic random access memory (DRAM) 26A-26N.

FIG. 2 shows details of the first memory partition 22A shown in FIG. 1. As discussed above, the first memory partition 22A includes a first memory controller 24A and a first portion of off-die global DRAM 26A. The first memory controller 24A includes a level two (L2) cache 28, a request queue 30, a DRAM scheduler 32, and a return queue 34. When a memory access request is received via the GPU interconnection network 20 at the first memory partition 22A, it is directed to the first memory controller 24A. Once a request is received, a lookup is performed in the L2 cache 28. If the request cannot be completed by the L2 cache 28 (e.g., if there is an L2 cache miss), the request is sent to the DRAM scheduler 32 via the request queue 30. When the DRAM scheduler 32 is ready, the request is processed, and any requested data is retrieved from the off-die global DRAM 26A. If there is any requested data, it is then sent back to the L2 cache 28 via the return queue 34, and subsequently sent over the GPU interconnection network 20 to the requesting device.

In operation, the traditional heterogeneous computing system 10 receives commands from a user specifying one or more operations to be performed in association with the execution of a kernel. Generally, the user will have access to an application programming interface (API), which allows the user to issue commands to the heterogeneous computing system 10 using a software interface. There are typically four operations associated with a kernel offload from the CPU 12 to the GPU 14. First, the computational kernel must be copied from the memory of the CPU 12 to the memory of the GPU 14. Next, the kernel must be executed by the GPU 14, and the results stored into the memory of the GPU 14. The results from the execution of the kernel must then be copied from the memory of the GPU 14 back to the memory of the CPU 12. An additional synchronization operation is also generally performed to ensure that the CPU 12 does not prematurely terminate or interrupt any of the kernel offload operations.

FIG. 3 shows a timeline representation of the operations associated with a CPU 12 to GPU 14 kernel offload in the traditional heterogeneous computing system 10. Each operation is addressed in turn, and is referred to by an exemplary API call associated with the operation. As discussed above, the first operation associated with a kernel offload is the copying of the kernel from the memory of the CPU 12 to the memory of the GPU 14. This is referred to as a “CopytoGPU” operation. In a compute unified device architecture (CUDA) based GPU system, this may be referred to as a “MemcpyHtoD” operation. To initiate the CopytoGPU operation, an API call is made by the user indicating that this operation should be performed (step 100). On receipt of the CopytoGPU API call, the CPU 12 initiates drivers for communicating with the hardware of the heterogeneous computing system 10 in order to effectuate copying of the kernel from the memory of the CPU 12 to the memory of the GPU 14 (step 102). The kernel is then copied from the memory of the CPU 12 to the memory of the GPU 14 (step 104).

The next operation associated with the CPU 12 to GPU 14 kernel offload is the execution of the kernel. This is referred to as a “Kernel” operation. To initiate the Kernel operation, an API call is made by the user indicating that this operation should be performed (step 106). In the traditional heterogeneous computing system 10, this is generally performed directly after the API call for the CopytoGPU operation (step 100) is made. On receipt of the Kernel API call, there is a slight delay while the CPU 12 completes initiation of the drivers associated with the CopytoGPU operation (step 102). The CPU 12 then initiates drivers for communicating with the hardware of the heterogeneous computing system 10 in order to effectuate the execution of the kernel (step 108). Upon completion of the driver initialization (step 108), the Kernel operation waits for a synchronization event to occur indicating that it is safe to begin execution of the kernel without encountering a portion of the kernel that has not yet arrived in the memory of the GPU 14. When the synchronization event occurs (step 110), the kernel is executed by the GPU 14 (step 112), and the resultant data is stored in the memory of the GPU 14. The traditional heterogeneous computing system 10 employs an event-based coarse synchronization scheme, in which synchronization is accomplished at this point only after the CPU 12 has indicated that all of the data associated with the kernel has been transferred to the GPU 14. Accordingly, execution of the kernel cannot begin until the CopyToGPU operation has completed, thereby contributing to the overhead associated with the kernel offload.

The next operation associated with the CPU 12 to GPU 14 kernel offload is the copying of the resultant data from the kernel execution from the memory of the GPU 14 back to the memory of the CPU 12. This is referred to as a “CopytoCPU” operation. In a CUDA based GPU system, this may be referred to as a “MemcpyDtoH” operation. To initiate the CopytoCPU operation, an API call is made by the user indicating that this operation should be performed (step 114). In the traditional heterogeneous computing system 10, this is generally performed directly after the API call for the Kernel operation (step 106) is made. On receipt of the CopytoCPU API call, there is a slight delay while the CPU 12 completes initialization of the drivers associated with the Kernel operation (step 108). The CPU 12 then initiates drivers for communicating with the hardware of the heterogeneous computing system 10 in order to effectuate copying of the resultant data from the memory of the GPU 14 to the memory of the CPU 12 (step 116).

Upon completion of the driver initialization (step 116), the CopytoCPU operation waits for a synchronization event to occur indicating that it is safe to begin copying the resultant data from the memory of the GPU 14 to the memory of the CPU 12 without encountering a portion of the resultant data that has not yet been determined or written to memory by the GPU 14. When the synchronization event occurs (step 118), the resultant data is copied from the memory of the GPU 14 back to the memory of the CPU 12 (step 120). As discussed above, the traditional heterogeneous computing system 10 employs an event-based coarse synchronization scheme, in which synchronization is accomplished at this point only after the GPU 14 has indicated that execution of the kernel is complete. Accordingly, copying of the resultant data from the memory of the GPU 14 to the memory of the CPU 12 cannot begin until the Kernel operation has completed, thereby contributing to the overhead associated with the kernel offload.

The final operation associated with the CPU 12 to GPU 14 kernel offload is a synchronization process associated with the kernel offload as a whole. This is referred to as a “Sync” operation, and is used to ensure that the processing of the offloaded kernel will not be terminated or interrupted prematurely. In a CUDA based GPU system, this may be referred to as a “StreamSync” operation. To initiate the Sync operation, an API call is made by the user indicating that this operation should be performed (step 122). In the traditional heterogeneous computing system 10, this is generally performed directly after the API call for the CopytoCPU operation (step 114) is made. The Sync API call persists at the CPU 12 until a synchronization event occurs indicating that all of the operations associated with the kernel offload (CopytoGPU, Kernel, and CopytoCPU) have completed, thereby blocking any additional API calls that may be made by the user. Upon occurrence of the synchronization event (step 124), the Sync operation ends, and control is restored to the user.

Although the traditional heterogeneous computing system 10 is suitable for kernels that are highly amenable to parallel processing, the overhead cost associated with offloading a kernel in the traditional heterogeneous computing system 10 precludes its application in many cases. The latency associated with data transfer, kernel launch, and synchronization significantly impedes the performance of the offloading operation in the traditional heterogeneous computing system 10. Accordingly, there is a need for a heterogeneous computing system that is capable of offloading computational kernels from a CPU to a GPU with a reduced overhead.

Those skilled in the art will recognize improvements and modifications to the preferred embodiments of the present disclosure. All such improvements and modifications are considered within the scope of the concepts disclosed herein and the claims that follow.

### SUMMARY

A heterogeneous computing system includes a central processing unit (CPU) and a graphics processing unit (GPU). The CPU and GPU are synchronized using a data-based synchronization scheme, wherein offloading of a kernel from the CPU to the GPU is coordinated based on the data associated with the kernel transferred between the CPU and the GPU. By using a data-based synchronization scheme, additional synchronization operations between the CPU and GPU are reduced or eliminated, and the overhead of offloading a process from the CPU to the GPU is reduced.

According to one embodiment, the CPU and GPU are synchronized using a data-based fine synchronization scheme, wherein offloading of a kernel from the CPU to the GPU is coordinated based upon a subset of the data associated with the kernel transferred between the CPU and the GPU. By using a data-based fine synchronization scheme, performance enhancements may be realized by the heterogeneous computing system, and the overhead of offloading a process from the CPU to the GPU is reduced.

According to one embodiment, the data-based fine synchronization scheme is used to start execution of a kernel early, before the all of the input data has arrived in the memory of the GPU. By starting execution of the kernel before the entire kernel has arrived at the GPU, the overhead of offloading a process from the CPU to the GPU is reduced.

According to one embodiment, the data-based fine synchronization scheme is used to start the transfer of data from the GPU back to the CPU early, before the GPU has finished processing the kernel. By starting the transfer of data from the GPU back to the CPU before the GPU has finished processing the kernel, the overhead of offloading a process from the CPU to the GPU is reduced.

According to one embodiment, the data-based fine synchronization is accomplished using a full/empty bit associated with each unit of memory in the GPU. When one or more write operations are performed on a unit of memory in the GPU, the full/empty bit associated with that unit of memory is set. When one or more read operations are performed on a unit of memory in the GPU, the full/empty bit associated with that unit of memory is cleared. Accordingly, data-based fine synchronization may be performed between the CPU and GPU at any desired resolution, thereby allowing the heterogeneous computing system to realize performance enhancements and reducing the overhead associated with offloading a process from the CPU to the GPU.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a schematic representation of a traditional heterogeneous computing system.

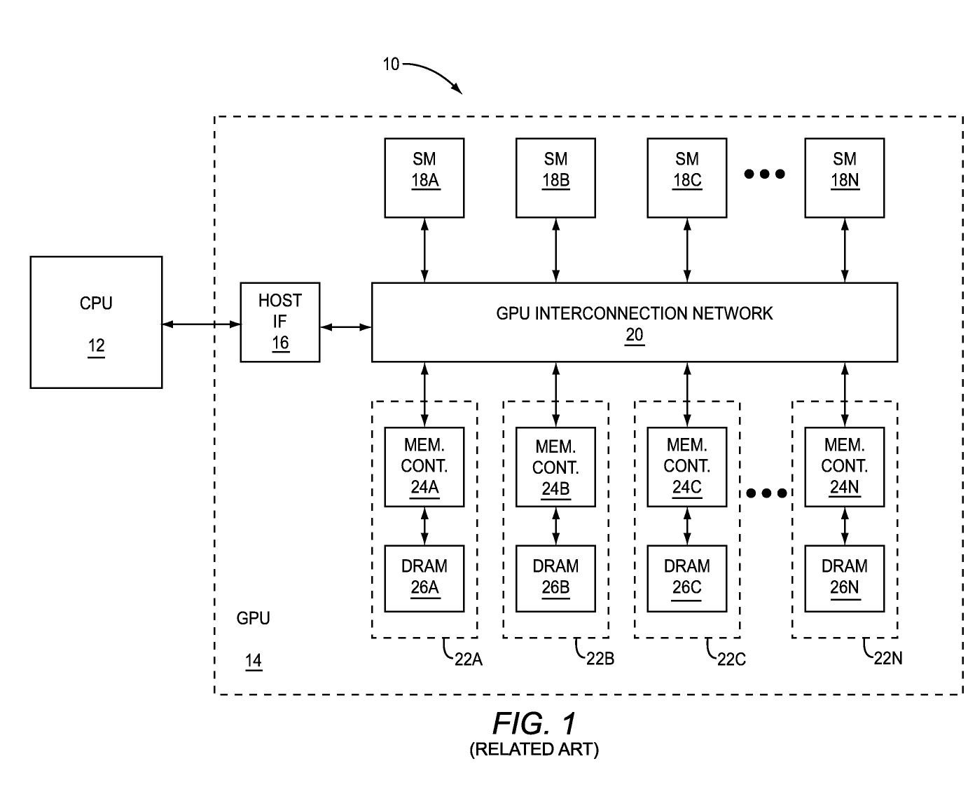

FIG. 2 shows details of the first memory partition of the graphics processing unit (GPU) shown in the traditional heterogeneous computing system of FIG. 1.

FIG. 3 is a timeline representation of the operations associated with a kernel offload in the traditional heterogeneous computing system shown in FIG. 1.

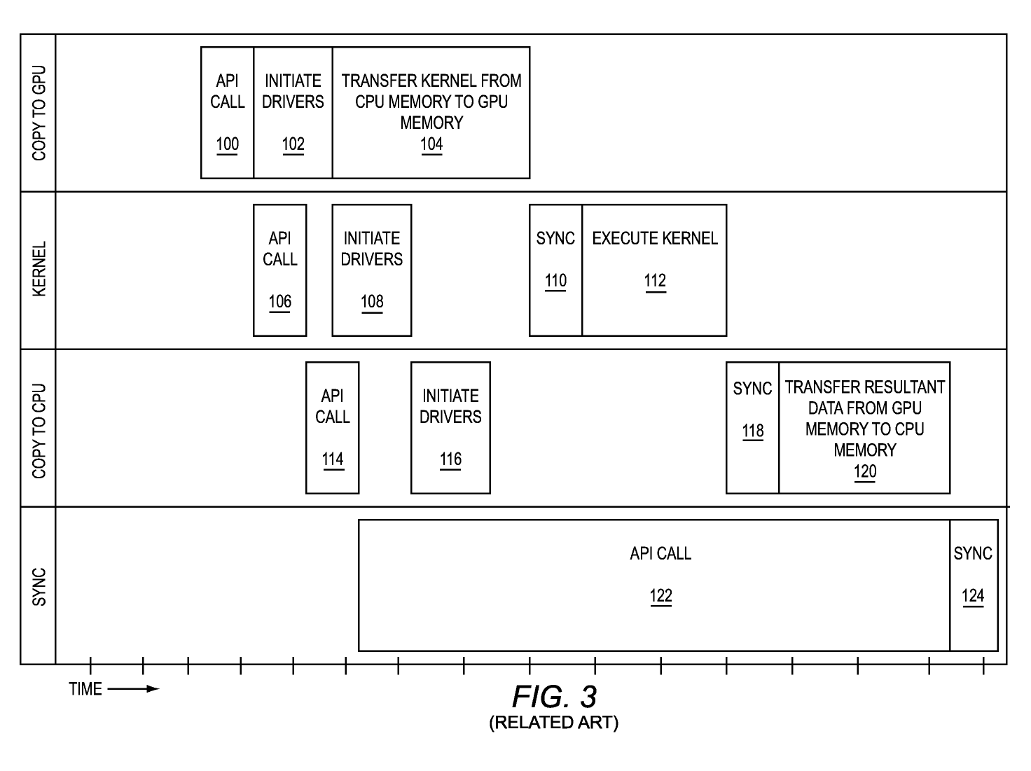

FIG. 4 is a schematic representation of a heterogeneous computing system according to one embodiment of the present disclosure.

FIG. 5 is a timeline representation of the operations associated with a kernel offload in the heterogeneous computing system shown in FIG. 4.

FIG. 6 shows details of the first memory partition of the GPU shown in the heterogeneous computing system shown in FIG. 4.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

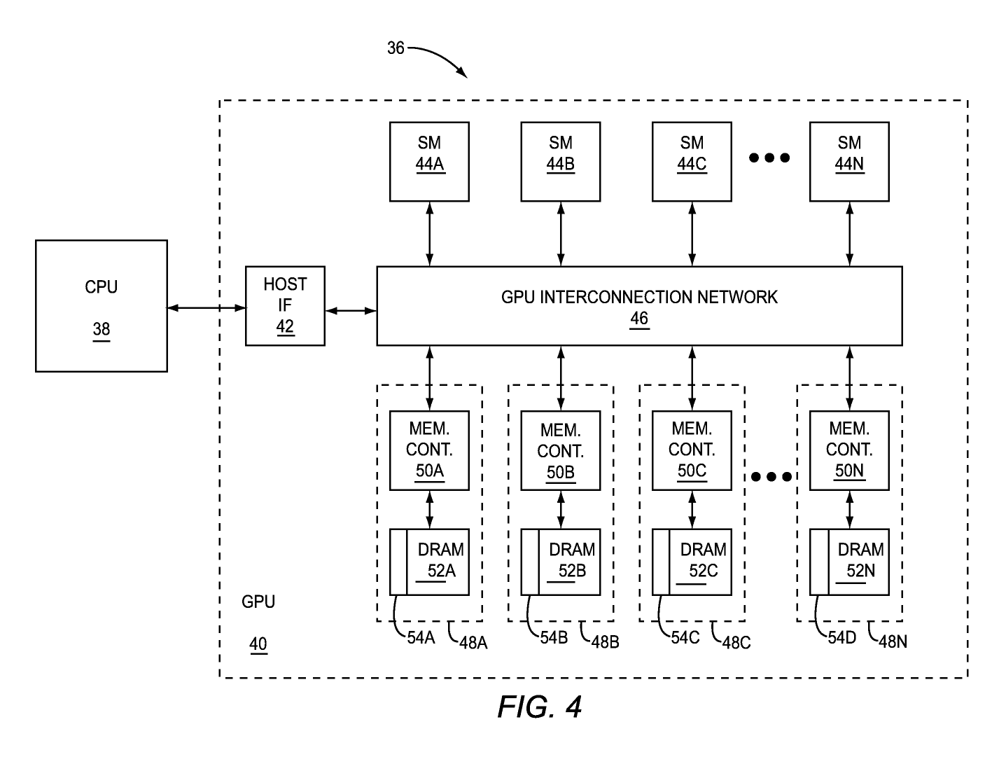

Turning now to FIG. 4, a schematic representation of a heterogeneous computing system 36 employing a data-based fine synchronization scheme is shown according to one embodiment of the present disclosure. The heterogeneous computing system 36 includes a central processing unit (CPU) 38 and a graphics processing unit (GPU) 40. The CPU 38 and the GPU 40 communicate via a host interface 42. The architecture of the GPU 40 includes two or more streaming multiprocessors 44A-44N, a GPU interconnection network 46, and two or more memory partitions 48A-48N. Each one of the memory partitions 48A-48N may include a memory controller 50A-50N and a portion of off-die global dynamic random access memory (DRAM) 52A-52N. According to one embodiment, at least a portion of the off-die global DRAM 52A-52N associated with each one of the memory partitions 48A-48N includes a section dedicated to the storage of full/empty (F/E) bits 54A-54N. Although the sections of memory dedicated to the storage of F/E bits 54A-54N are shown located in the off-die global DRAM 52A-52N, the F/E bits may be stored on any available memory or cache in the GPU 40 without departing from the principles of the present disclosure. The F/E bits allow the heterogeneous computing system 36 to employ a data-based fine synchronization scheme in order to reduce the overhead associated with offloading a kernel from the CPU 38 to the GPU 40, as will be discussed in further detail below.

The F/E bits may include multiple bits, wherein each bit is associated with a particular unit of memory of the GPU 40. In one exemplary embodiment, each bit in the plurality of F/E bits is associated with a four byte word in memory, however, each F/E bit may be associated with any unit of memory without departing from the principles of the present disclosure. Each F/E bit may be associated with a trigger condition and an update action. The trigger condition defines how to handle each request to the unit of memory associated with the F/E bit. For example, the trigger condition may indicate that the request should wait until the F/E bit is full to access the associated unit of memory, wait until the F/E bit is empty to access the associated unit of memory, or to ignore the F/E bit altogether. When the request is processed, the update action directs whether the F/E bit should be filled, emptied, or left unchanged as a result. The F/E bits may be used by the heterogeneous computing system 36 to employ a data-based fine synchronization scheme, as will be discussed in further detail below.

According to one embodiment, memory requests may be categorized into three classes for determining the appropriate trigger and update condition. First, for memory requests originating at the CPU 38, the triggers and actions may be explicitly specified by the user via one or more API extensions. For memory requests originating at the GPU 40, reads may have a fixed trigger of waiting for the associated F/E bit to be marked as full with no action, while writes may have no trigger and an implicit action of marking the F/E bit as full.

According to one exemplary embodiment, the CPU 38 and the GPU 40 are in a consumer-producer relationship. For example, if the GPU 40 wishes to read data provided by the CPU 38, the GPU 40 will issue a read request with a trigger condition specifying that it will not read the requested memory until the F/E bit associated with the requested memory is marked full. Until the CPU 38 sends the data, the F/E bit associated with the requested memory is set to empty, and the GPU 40 will block the request. When the CPU 38 writes the data to the requested memory location, the F/E bit associated with the requested memory is filled, and the GPU 40 executes the read request safely. For coalesced requests, the responses are returned when all the relevant F/E bits indicate readiness.

The memory system of the GPU 40 is designed to support a large number of threads executing simultaneously. Accordingly, the GPU interconnection network 46 allows each one of the plurality of streaming multiprocessors 44A-44N to access the plurality of memory partitions 48A-48N. The basic memory space of the GPU 40 may be presented as a large random access memory (RAM), and can be either physically separate (for discrete GPUs) or logically separate (for integrated GPUs) from the memory of the CPU 38. Requests to contiguous locations in GPU 40 memory may be coalesced into fewer, larger arrays to make efficient use of the GPU interconnection network 46.

In operation, the heterogeneous computing system 36 receives commands from a user specifying one or more operations to be performed in association with the execution of a kernel. Generally, the user will have access to an application programming interface (API), which allows the user to issue commands to the heterogeneous computing system 36 using a software interface. There are typically four operations associated with a kernel offload from the CPU 38 to the GPU 40. First, the computational kernel must be copied from the memory of the CPU 38 to the memory of the GPU 40. Next, the kernel must be executed by the GPU 40, and the results stored into the memory of the GPU 40. The results from the execution of the kernel must then be copied from the memory of the GPU 40 back to the memory for the CPU 38. An additional synchronization operation is also generally performed to ensure that the CPU 38 does not prematurely terminate or interrupt any of the kernel offload operations.

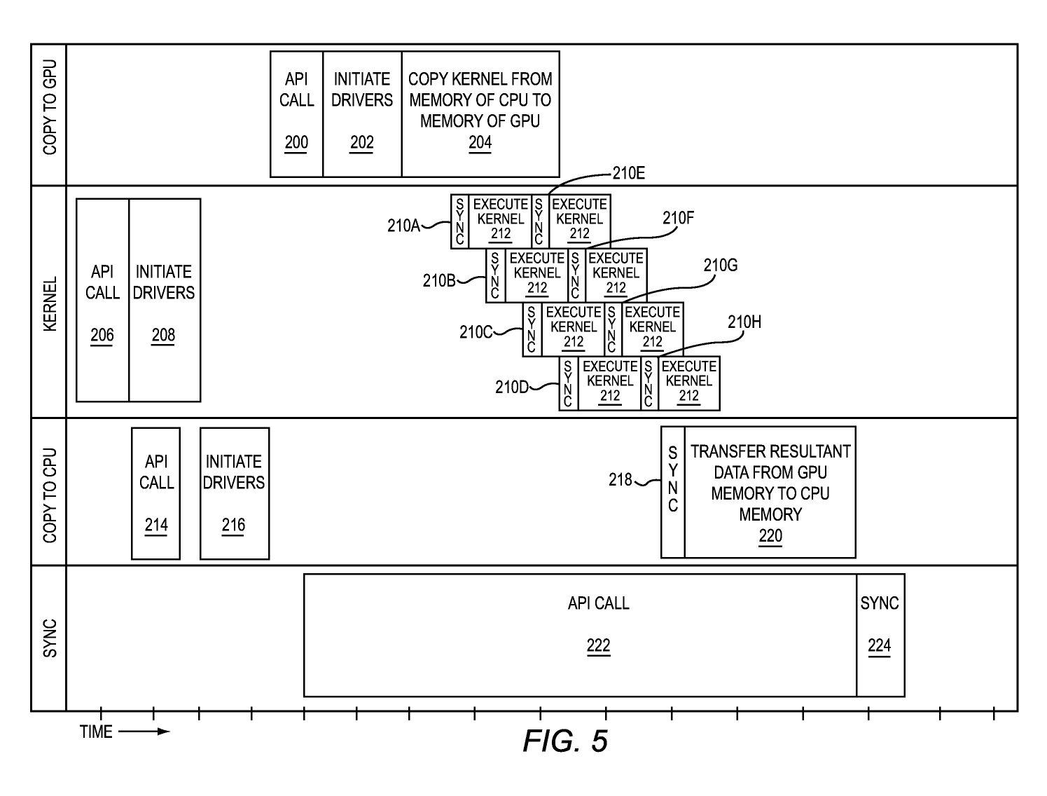

FIG. 5 shows a timeline representation of the operations associated with a CPU 38 to GPU 40 kernel offload for the heterogeneous computing system 36 employing a data-based fine synchronization scheme. Each operation is addressed in turn, and is referred to by an exemplary API call associated with the operation. Although specific API calls are used herein to describe the various operations associated with the kernel offload, these API calls are merely exemplary, as will be appreciated by those of ordinary skill in the art.

As discussed above, the first operation associated with a kernel offload is the copying of the kernel from the memory of the CPU 38 to the memory of the GPU 40. This is referred to as a “CopytoGPU” operation. In a compute unified device architecture (CUDA) based GPU system, this may be referred to as a “MemcpyHtoD” operation. To initiate the CopytoGPU operation, an API call is made by the user indicating that this operation should be performed (step 200). On receipt of the CopytoGPU API call, the CPU 38 initiates drivers for communicating with the hardware of the heterogeneous computing system 36 in order to effectuate copying of the kernel from the memory of the CPU 38 to the memory of the GPU 40 (step 202). The kernel is then copied from the memory of the CPU 38 to the memory of the GPU 40 (step 204). According to one embodiment, as the data associated with the kernel is being copied from the memory of the CPU 38 to the memory of the GPU 40, the F/E bit associated with each unit of memory in the GPU 40 filled by the kernel data is updated, indicating that it is safe for the GPU 40 to read and act upon the particular unit of memory. By updating the F/E bit associated with each unit of memory in the GPU 40 filled by the kernel data, a data-based fine synchronization scheme is created, thereby allowing the heterogeneous computing system 36 to utilize performance improvements in the execution of the kernel, as will be discussed in further detail below.

According to one embodiment, the heterogeneous computing system 36 includes an integrated CPU/GPU, wherein the CPU 38 and the GPU 40 share a memory space. The shared memory space may be physically shared, logically shared, or both. Accordingly, the CopytoGPU operation may not involve a physical copy of the kernel data from one memory location to another, but instead may involve making the kernel data in the shared memory space available to the GPU 40.

The next operation associated with the CPU 38 to GPU 40 kernel offload is the execution of the kernel. This is referred to as a “Kernel” operation. To initiate the Kernel operation, an API call is made by the user indicating that this operation should be performed (step 206). In the heterogeneous computing system 36 employing a data-based fine synchronization scheme, the Kernel API call is made in advance, since the timing involved in the execution of the kernel is no longer critically based on the completion of the CopytoGPU operation. On receipt of the Kernel API call, the CPU 38 initiates drivers for communicating with the hardware of the heterogeneous computing system 36 in order to effectuate the execution of the kernel (step 208). The Kernel operation then waits for a synchronization event to occur indicating that it is safe to begin execution of the kernel without encountering a portion of the input data that has not yet arrived in the memory of the GPU 40. Upon the occurrence of the synchronization event (steps 210A-210H), the kernel is executed by the GPU 40 (step 212), and the resultant data is written into the memory of the GPU 40.

As discussed above, the heterogeneous computing system 36 employs a data-based fine synchronization scheme, wherein synchronization between the CPU 38 and the GPU 40 is based upon the arrival of a subset of data associated with the kernel in the memory of the GPU 38. As part of the data-based fine synchronization scheme, the GPU 40 may read the F/E bit associated with each unit of memory in order to determine whether or not the data contained in the unit of memory is safe to read. If the unit of memory is safe to read, the GPU 40 will read and act upon the data. If the unit of memory is not safe to read, the GPU 40 will wait until the status of the F/E bit changes to indicate that the data is safe to read. Because the F/E bit associated with each unit of memory of the GPU 40 was updated as the kernel data was written into it, the synchronization between the CPU 38 and the GPU 40 is based upon the arrival of data in the memory of the GPU 40, and can be accomplished at any desired resolution.

The multiple synchronization events (steps 210A-210H) shown for the Kernel process exemplify the reading of a F/E bit associated with a unit of memory in the GPU 40. As is shown, multiple synchronization events (steps 210A-210H) may occur during the execution of the kernel, as the GPU 40 may continually read the status of the F/E bits associated with the units of memory it is attempting to access. Accordingly, the execution of the kernel (step 212) may be broken into a series of operations interleaved with one of the multiple synchronization events (steps 210A-210H). By employing the data-based fine synchronization scheme, the kernel may be executed simultaneously with the copy of the kernel data from the memory of the CPU 38 to the memory of the GPU 40, thereby significantly reducing the overhead associated with offloading the kernel from the CPU 38 to the GPU 40. Additionally, the overhead associated with the synchronization event itself is reduced, because no extraneous communication between the CPU 38 and the GPU 40 is necessary to accomplish the synchronization.

According to one embodiment, early execution of the kernel may be initiated in the heterogeneous computing system 36 via an additional API extension. Accordingly, the user may control the timing of the kernel execution. According to an additional embodiment, the heterogeneous computing system 36 automatically starts execution of the kernel as soon as possible, regardless of input from the user.

According to one embodiment, as the resultant data from the execution of the kernel is written into the memory of the GPU, the F/E bit associated with each unit of memory filled by the resultant data is updated, indicating that it is safe to copy the contents of the particular unit of memory back to the CPU. By updating the F/E bit associated with each unit of memory in the GPU 40 filled by the resulting data, further support is added to the data-based fine synchronization scheme, thereby allowing the heterogeneous computing system 36 to utilize additional performance improvements in the execution of the kernel, as will be discussed in further detail below.

The next operation associated with the CPU 38 to GPU 40 kernel offload is the copying of the resultant data from the memory of the GPU 40 back to the memory of the CPU 38. This is referred to as a “CopytoCPU” operation. In a CUDA based GPU system, this may be referred to as a “MemcpyDtoH” operation. To initiate the CopytoCPU operation, a API call is made by the user indicating that his operation should be performed (step 214). In the heterogeneous computing system 36 employing a data-based fine synchronization scheme, the CopytoCPU API call is made directly after the Kernel API call (step 206) is made. On receipt of the CopytoCPU API call, there is a slight delay while the CPU 38 completes initialization of the drivers associated with the Kernel operation (step 208). The CPU 38 then initiates drivers for communicating with the hardware of the heterogeneous computing system 36 in order to effectuate copying of the resultant data from the memory of the GPU 40 to the memory of the CPU 38 (step 216). Upon completion of the initialization of the drivers, the CopytoCPU operation waits for a synchronization event to occur indicating that it is safe to begin copying the resultant data from the memory of the GPU 40 to the memory of the CPU 38 without encountering a portion of the resultant data that has not yet been determined or written to memory by the GPU 40. When the synchronization event occurs (step 218), the resultant data is copied from the memory of the GPU 40 back to the memory of the CPU 38 (step 220).

As discussed above, the heterogeneous computing system 36 employs a data-based fine synchronization scheme. As part of the data-based fine synchronization scheme, the GPU 40 may read the F/E bit associated with each unit of memory in order to determine whether it is safe to copy the contents of the unit of memory back to the CPU 38. If it is safe to copy the contents of the unit of memory back to the CPU 38, the GPU 40 will do so. If it is not safe to copy the contents of the unit of memory back to the CPU 38, the GPU 40 will wait until the status of the F/E bit changes indicating that it is safe to copy the contents of the unit of memory back to the CPU 38. Accordingly, the synchronization between the CPU 38 and the GPU 40 is based upon the arrival of data in the memory of the GPU 40, and can be accomplished at any desired resolution. By employing the data-based fine synchronization scheme, the copying of resultant data from the memory of the GPU 40 to the memory of the CPU 38 may occur simultaneously with the execution of the kernel, thereby significantly reducing the overhead associated with offloading the kernel from the CPU 38 to the GPU 40. Additionally, the overhead associated with the synchronization event itself is reduced, because no extraneous communication between the CPU 38 and the GPU 40 is necessary to accomplish the synchronization.

According to one embodiment, early copying of the resultant data from the memory of the GPU 40 to the memory of the CPU 38 may be initiated in the heterogeneous computing system 36 via an additional API extension. Accordingly, the user may control the timing of the copy of the resultant data. According to an additional embodiment, the heterogeneous computing system 36 automatically starts the copying of the resultant data as soon as possible, regardless of input from the user.

According to one embodiment, the heterogeneous computing system 36 includes an integrated CPU/GPU, wherein the CPU 38 and the GPU 40 share a memory space. The shared memory space may be physically shared, logically shared, or both. Accordingly, the CopytoCPU operation may not involve a physical copy of the kernel data from one memory location to another, but instead may involve making the kernel data in the shared memory space available to the CPU 38.

The final operation associated with the CPU 38 to GPU 40 kernel offload is a synchronization process associated with the kernel offload as a whole. This is referred to as a “Sync” operation, and is used to ensure that the processing of the offloaded kernel will not be terminated or interrupted prematurely. In a CUDA based GPU system, this may be referred to as a “StreamSync” operation. To initiate the Sync operation, an API call is made by the user indicating that this operation should be performed (step 222). In the heterogeneous computing system 36, this is generally performed after the API call for the CopytoGPU (step 200) is made. The Sync API call persists at the CPU 38 until a synchronization event occurs indicating that all of the operations associated with the kernel offload (CopytoGPU, Kernel, and CopytoCPU) have completed, thereby blocking any additional API calls that may be made by the user. Upon occurrence of the synchronization event (step 224), the Sync operation ends, and control is restored to the user.

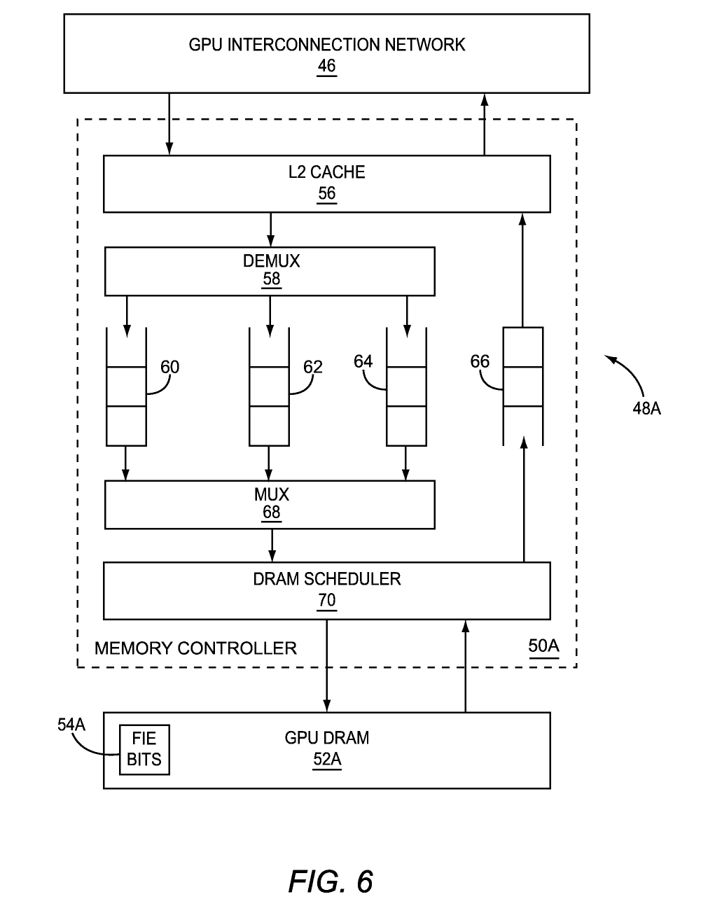

FIG. 6 shows details of the first memory partition 48A shown in FIG. 4 according to one embodiment of the present disclosure. As discussed above, the first memory partition 48A includes a first memory controller 50A and a first portion of off-die global DRAM 52A. The first memory controller 50A includes a level two (L2) cache 56, a demultiplexer 58, a non-triggered queue 60, a CPU triggered queue 62, a GPU triggered queue 64, a return queue 66, a multiplexer 68, and a DRAM scheduler 70.

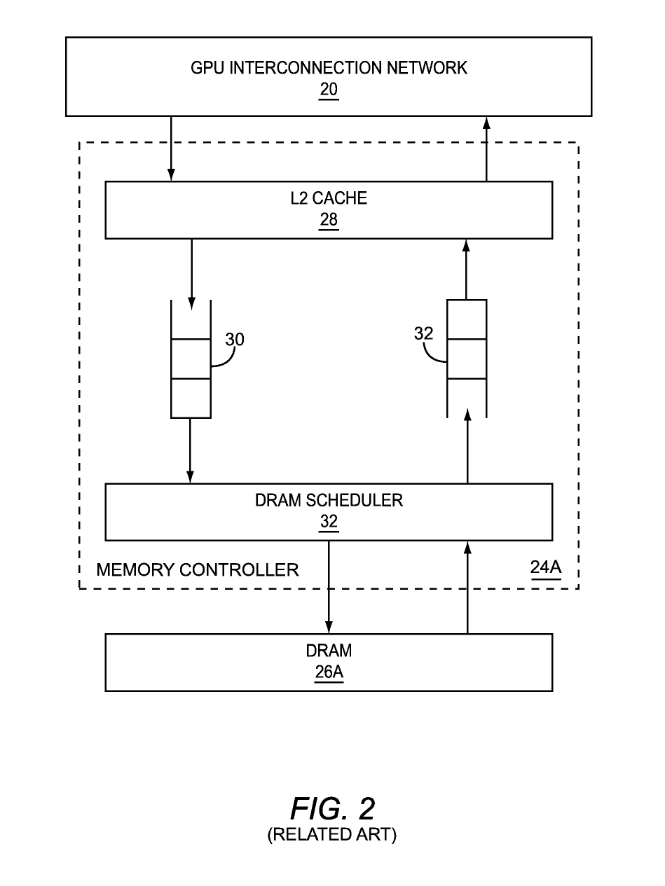

When a memory access request is received via the GPU interconnection network 46 at the first memory partition 48A, it is directed to the first memory controller 50A. Once a request is received, a lookup is performed in the L2 cache 56. If the request cannot be completed by the L2 cache 56 (e.g., if there is an L2 cache miss), the request is sent to the demultiplexer 58. The demultiplexer 58 separates the requests into non-triggered requests, CPU-based triggered requests, and GPU-based triggered requests, and directs the requests to either the non-triggered queue 60, the CPU triggered queue 62, or the GPU triggered queue 64, respectively. A non-triggered request is a memory request whose completion does not depend on the status of the F/E bit associated with the requested memory address. A CPU-based triggered request is a memory request sent from the CPU 38 whose completion does depend on the status of the F/E bit associated with the requested memory address. A GPU-based triggered request is a memory request sent from the GPU 40 whose completion does depend on the status of the F/E bit associated with the requested memory address. If a CPU-based triggered request is received at the first memory partition 48A with an unsatisfied trigger condition, the request has the potential to stall all other requests in the queue until the trigger condition is satisfied. Because the write request that will satisfy the original request may be positioned behind the stalled request, using a data-based fine synchronization scheme with the traditional memory controller shown in FIG. 2 may stall the kernel offload indefinitely. Accordingly, the CPU triggered queue 62 and the GPU triggered queue 64 are provided to ensure that write requests to the off-die global DRAM 52A can be routed around a stalled request with an unsatisfied trigger condition.

Once the requests are routed to the appropriate queue, they are sent to the multiplexer 68, where they are recombined and forwarded to the DRAM scheduler 70. The DRAM scheduler 70 processes the request and retrieves any requested data from the off-die global DRAM 52A. If there is any requested data, it is sent back to the L2 cache 56 via the return queue 66, and subsequently sent over the GPU interconnection network 46 to the requesting device.

Those skilled in the art will recognize improvements and modifications to the preferred embodiments of the present disclosure. All such improvements and modifications are considered within the scope of the concepts disclosed herein and the claims that follow.

What is claimed is:

1. A computing system comprising a central processing unit (CPU) including a first memory space and a graphics processing unit (GPU) including a second memory space, wherein the CPU and the GPU cooperate to synchronize an offload of a computational kernel from the CPU to the GPU based upon the arrival of data associated with the computational kernel in the second memory space.

2. The computing system of claim 1 wherein the CPU and the GPU cooperate to synchronize the offload of the computational kernel from the CPU to the GPU based upon the arrival of a subset of data associated with the computational kernel in the second memory space.

3. The computing system of claim 2 wherein offloading the computational kernel comprises:
copying the data associated with the computational kernel from the first memory space to the second memory space;
executing the computational kernel on the GPU; and
copying resultant data associated with the execution of the computational kernel from the second memory space to the first memory space.

4. The computing system of claim 3 wherein executing the computational kernel on the GPU is started as soon as a subset of the data associated with the computational kernel arrives in the second memory space.

5. The computing system of claim 3 wherein copying the resultant data from the execution of the computational kernel from the second memory space to the first memory space is started as soon as a subset of the resultant data is written into the second memory space.

6. A computing system comprising:
a central processing unit (CPU);
a graphics processing unit (GPU) including a plurality of full/empty bits, wherein each one of the full/empty bits is associated with a unit of memory in the GPU.

7. The computing system of claim 6 wherein each one of the plurality of full/empty bits is associated with a trigger condition that dictates the required status of the full/empty bit before the unit of memory associated with the full/empty bit can be accessed.

8. The computing system of claim 6 wherein each one of the plurality of full/empty bits is associated with an update action that dictates how the full/empty bit will be updated when the unit of memory associated with the full/empty bit is accessed.

9. The computing system of claim 7 wherein the GPU comprises:
a plurality of streaming multiprocessors;
a GPU interconnection network; and
a plurality of memory partitions, wherein the plurality of full/empty bits are stored on the plurality of memory partitions.

10. The computing system of claim 9 wherein each one of the plurality of memory partitions comprises:
a memory controller comprising:
a level two (L2) cache
a first memory request queue;
a second memory request queue;
a third memory request queue;
a DRAM scheduler; and
a return queue; and
a portion of off-die global dynamic random access memory (DRAM).

11. The computing system of claim 10 wherein the first memory request queue is used for memory requests without a trigger condition, the second memory request queue is used for memory requests originating from the CPU with a trigger condition, and the third memory request queue is used for memory requests originating from the GPU with a trigger condition.

12. The computing system of claim 6 wherein the computing system is adapted to offload a computational kernel from the CPU to the GPU.

13. The computing system of claim 12 wherein synchronization between the CPU and the GPU during the offload of the computational kernel is based upon the plurality of full/empty bits.

14. The computing system of claim 12 wherein offloading the computational kernel comprises:
copying data associated with the computational kernel from a first memory space associated with the CPU to a second memory space associated with the GPU;
executing the computational kernel on the GPU; and
copying resultant data associated with the execution of the computational kernel from the second memory space to the first memory space.

15. The computing system of claim 14 wherein copying the data associated with the computation kernel from the first memory space to the second memory space comprises:
writing the data associated with the computational kernel into the second memory space; and
updating a full/empty bit associated with each unit of memory written to in the second memory space.

16. The computing system of claim 15 wherein executing the computational kernel on the GPU is started when one or more of the plurality of full/empty bits indicates that a memory location updated while copying the data associated with the computational kernel from the first memory space to the second memory space can be safely read.

17. The computing system of claim 14 wherein executing the computational kernel on the GPU comprises:
executing the computational kernel;
writing the resultant data associated with execution of the computational kernel into the second memory space; and
updating the full/empty bit associated with each unit of memory written to in the second memory space.

18. The computing system of claim 17 wherein copying the resultant data associated with the execution of the computational kernel from the second memory space to the first memory space is started when one or more of the plurality of full/empty bits indicates that a memory location updated while executing the computational kernel can be safely read.

19. The computing system of claim 16 wherein executing the computational kernel on the GPU comprises:
executing the computational kernel;
writing the resultant data associated with the execution of the kernel into the memory of the GPU; and
updating the full/empty bit associated with each unit of memory written to in the second memory space.

20. The computing system of claim 19 wherein copying the resultant data associated with the execution of the computational kernel from the memory of the GPU to the memory of the CPU is started when one or more of the plurality of full/empty bits indicates that a memory location updated while executing the kernel can be safely read.

21. A method for offloading a computational kernel from a central processing unit (CPU) to a graphics processing unit (GPU) comprising:
copying data associated with the computational kernel from a first memory space associated with the CPU to a second memory space associated with the GPU;
updating a full/empty bit associated with each unit of memory written to in the second memory space.

22. The method of claim 21 further comprising:
executing the computational kernel on the GPU;
writing resultant data associated with the execution of the computational kernel into the second memory space; and
updating the full/empty bit associated with each unit of memory written to in the second memory space.

23. The method of claim 22, wherein executing the computational kernel on the GPU is started when one or more of the plurality of full/empty bits indicates that a memory location updated while copying the data associated with the computational kernel from the first memory space to the second memory space can be safely read.

24. The method of claim 22 further comprising:
copying the resultant data associated with the execution of the computational kernel from the second memory space to the first memory space.

25. The method of claim 24 wherein copying the resultant data associated with the execution of the computational kernel from the second memory space to the first memory space is started when one or more of the plurality of full/empty bits indicates that a memory location updated while executing the computational kernel can be safely read.

26. A computing system comprising a central processing unit (CPU), a graphics processing unit (GPU), and a shared memory space, wherein the CPU and the GPU cooperate to synchronize an offload of a computational kernel based upon the arrival of data associated with the computational kernel in the shared memory space.

27. The computing system of claim 26 wherein the CPU and the GPU cooperate to synchronize the offload of the computational kernel from the CPU to the GPU based upon the arrival of a subset of data associated with the computational kernel in the shared memory space.

28. A computing system comprising:
a central processing unit (CPU);
a graphics processing unit (GPU);
a shared memory space; and
a plurality of full/empty bits, wherein each one of the full/empty bits is associated with a unit of memory in the shared memory space.

29. The computing system of claim 28 wherein the computing system is adapted to offload a computational kernel from the CPU to the GPU.

30. The computing system of claim 29 wherein synchronization between the CPU and the GPU during the offload of the computational kernel is based upon the plurality of full/empty bits.
